(19) United States
(12) Patent Application Publication
(10) Pub. No.: US 2026/0342697 A1
(43) Pub. Date: Oct. 29, 2026

(54) REFERENCE SIGNAL REPORTING METHOD AND APPARATUS

(71) Applicant: ZTE Corporation, Shenzhen (CN)

(72) Inventors: Minqiang ZOU, Shenzhen (CN); Guangyu JIANG, Shenzhen (CN); Bo GAO, Shenzhen (CN); Ke YAO, Shenzhen (CN)

(21) Appl. No.: 19/673,528

(22) Filed: May 11, 2026

Related U.S. Application Data
(63) Continuation of application No. PCT/CN2024/074098, filed on Jan. 25, 2024.

(51) Int. Cl. H04L 43/065; H04B 7/06

(52) U.S. Cl. CPC H04L 43/065; H04B 7/0626; H04B 7/0632

(57) ABSTRACT

A wireless communication method includes receiving, by a communication device, from a network device, a reference signal and a configuration, determining, by the communication device, a report based on the one or more transmissions and the configuration; and transmitting, by the communication device, to the network device, the report. The reference signal may be channel state information reference signal.

### CROSS-REFERENCE TO RELATED APPLICATION

This application is a continuation and claims priority to International Application No. PCT/CN2024/074098, filed on Jan. 25, 2024, the disclosure of which is hereby incorporated by reference herein in its entirety

### TECHNICAL FIELD

This patent document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), and other wireless networks.

In one example aspect, a wireless communication method is disclosed. The method includes receiving, by a communication device, from a network device, a reference signal and a configuration, determining, by the communication device, a report based on the reference signal and the configuration, and transmitting, by the communication device, to the network device, the report.

In another example aspect, another wireless communication method is disclosed. The method includes transmitting, by a network device, to a communication device, a reference signal and a configuration, and receiving, by the network device, a report from the communication device, wherein the report is generated based on the reference signal and the configuration.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the above-described method.

The above and other aspects and their implementations are described in greater detail in the drawings, the descriptions, and the claims.

### BRIEF DESCRIPTION OF THE DRAWINGS

FIG. 1 is a block diagram example of a wireless communication system.

FIG. 2 is a flowchart of an example method of wireless communication.

FIG. 3 is a flowchart of an example of a wireless communication method.

FIG. 4 is a flowchart of an example of a wireless communication method.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

### 1. Introduction

Multiple-input, multiple-output (MIMO) is one of the key technologies in the New Radio (NR) systems and is successful in commercial deployment. In Rel-15/16/17, MIMO features were investigated and specified for both FDD (frequency division duplexing) and TDD (time division duplexing) systems.

To achieve higher downlink (DL) throughput, broader coverage range and flexibility of scheduling for multi-user, multi-input multi-output (MU-MIMO), a BS (Base Station) needs to be configured with more and more antenna ports, e.g., 64 or 128 ports in a reference signal resource set such as the channel state information reference signal (CSI-RS) resource set.

Presently in the third generation partnership project (3GPP) release standard, a communication device (e.g., a user equipment UE) is expected to derive CSI parameters on the reported only one CRI (CSI-RS resource indicator). If value of a parameter, called Kₛ=2, CSI-RS resources within a set are configured, each resource contains at most 16 CSI-RS ports. If 2<Kₛ≤8 CSI-RS resources within a set are configured, each resource contains at most 8 CSI-RS ports.

In current 3GPP specification, except for a CSI-ReportConfig configured with reportQuantity set to ‘cri-RI-PMI-CQI’ and codebookType set to ‘typeII-CJT-r18’, ‘typeII-CJT-PortSelection-r18’, ‘typeII-Doppler-r18’, or ‘typeII-Doppler-PortSelection-r18’, if the UE is configured with a CSI-ReportConfig with the higher layer parameter reportQuantity set to ‘cri-RSRP’, ‘cri-RI-PMI-CQI’, ‘cri-RI-i1’, ‘cri-RI-i1-CQI’, ‘cri-RI-CQI’, ‘cri-RI-LI-PMI-CQI’, ‘cri-SINR’, or ‘cri-SINR-Index’, and Kₛ>1 resources are configured in the corresponding resource set for channel measurement, then the UE is expected to derive the CSI parameters on the reported only one CRI (CSI-RS resource indicator), where CRI k (k≥0) corresponds to the configured (k+1)-th entry of associated nzp-CSI-RS-Resources in the corresponding NZP-CSI-RS-ResourceSet for channel measurement, and (k+1)-th entry of associated csi-IM-Resource in the corresponding csi-IM-ResourceSet (if configured) or (k+1)-th entry of associated nzp-CSI-RS-Resources in the corresponding NZP-CSI-RS-ResourceSet (if configured for CSI-ReportConfig with reportQuantity set to ‘cri-SINR’ or ‘cri-SINR-Index’) for interference measurement.

In some embodiments disclosed in the present document, more than one CRI may be reported and UE may derive more CSI parameters on these reported CRIs, which is also called extension of CRI(s)-based CSI reporting. In some embodiments, channel quality indicator (CQI), precoding matrix indicator (PMI) or rank indicator (RI) may be calculated per CRI (for >=1 CRIs) for hybrid beamforming. Moreover, each resource within a set may contain at most 32 or more than 32 CSI-RS ports. Specifically, the method includes the following embodiments:

As further discussed in the present document in a first set of embodiments, reference signal configuration, with specially showing examples of CSI-RS configuration, is enhanced. In a second set of embodiments, multiple sets of CSI parameters (CRI, RI, PMI, CQI) reporting methods are used. In a third set of embodiments, CSI reporting using different physical channels such as the physical uplink control channel (PUCCH) or the physical uplink shared channel (PUSCH) is enhanced for multiple sets of CSI parameters. In a fourth set of embodiments, CSI report priority calculation is provided for CRI(s)-based CSI reporting.

In future, more than one CRI will be reported and UE will derive more CSI parameters on these reported CRIs, which is also called extension of CRI(s)-based CSI reporting (CQI/PMI/RI calculated per CRI for >=1 CRIs) for hybrid beamforming. Moreover, if Kₛ=2 CSI-RS resources are configured, each resource shall contain at most 32 or more than 32 CSI-RS ports. If 2<Kₛ CSI-RS resources are configured, each resource shall contain at most 32 or more than 32 CSI-RS ports, too. The parameter Kₛ represents number of resources.

### Embodiment 0: The General Procedure of CSI Reporting

According to some embodiments, UE receives a configuration signaling and CSI-RS from a BS. Next, UE determines a CSI based on the configuration signaling and CSI-RS, where the CSI may include one or more Channel Quality Indicator (CQI)s, one or more precoding matrix indicators (PMI), one or more layer indicators (LI), one or more rank indicators (RI) or one or more CSI-RS resource indicators (CRI); UE sends the CSI report to BS.

In some embodiments, wherein the CSI-RS may consist of K CSI-RS resources, the slot offsets of the K CSI-RS resources are configured within Xϵ{1, 2, . . . N} slots, without DL/UL (downlink/uplink) switching in between the two resources, where X=1 implies that the K resources are configured in the same slot, and X=2 implies that the K resources are configured within two adjacent slots . . . . If K>=4, and each resource contains more than 16 or 32 CSI-RS ports, the value of X should be X>=2.

In some embodiments, K CSI-RS resources are configured in a CSI-RS resource set, and each resource will contain up to 32 or more than 32 CSI-RS ports.

### Embodiment 1: CSI-RS Configuration

In some implementations according to Embodiment 1, K CSI-RS resources are configured by gNB for channel measurement. K is a positive integer. K may be greater than 1.

In some embodiments, the K CSI-RS resources are configured in a CSI-RS resource set, and each resource shall contain 32 or more than 32 CSI-RS ports. The slot offsets of the K CSI-RS resources are configured within Xϵ{1, 2, . . . N} slots, without DL/UL switching in between the two resources, where X=1 implies that the K resources are configured in the same slot, and X=2 implies that the K resources are configured within two adjacent slots . . . . If K>=4, and each resource contains more than 16 or 32 CSI-RS ports, the value of X should be X>=2. There may be some restrictions for Inter CSI-RS resource time offset. For example, the allowed maximum/minimum time offset between adjacent CSI-RS resources is configured by gNB or up to UE capability.

In some embodiments, the equal time offset is configured by gNB or up to UE capability between adjacent CSI-RS resources.

In some embodiments, the K CSI-RS resources are configured in one CSI-RS resource setting, one CSI-RS resource set or G CSI-RS resource groups. The value of G is configured by gNB or high layer parameter. Furthermore, embodiments may adopt one or more of the following features:
The parameter powerControlOffset is same or different for each CSI-RS resource.
The parameter powerControlOffsetSS is same or different for each CSI-RS resource.
If interference measurement is performed on CSI-IM, only one resource is configured.
If interference measurement is performed on CSI-IM, K resources are configured.
If interference measurement is performed on NZP-CSI-RS, only one resource is configured.
If interference measurement is performed on NZP-CSI-RS, K resources are configured.

### Embodiment 2: CSI Report

According to some implementations of Embodiment 2, K CSI-RS resources are configured by gNB for channel measurement. K is a positive integer. K may be greater than 1.

In some embodiments, UE determines L sets of CRI, RI, PMI, CQI within a CSI report. 1<=L<=K, The value of L is configured by gNB or reported by UE.

In some embodiments, UE determines L sets of CRI, RI, PMI, CQI within separate L CSI reports. 1<=L<=K, The value of L is configured by gNB or reported by UE.

Implementations may further adopt one or more of the following features:
K specific RI restrictions are configured for K CSI-RS resources
One common RI restriction is configured for K CSI-RS resources
K specific codebookSubsetRestrictions are configured for K CSI-RS resources
One common codebookSubsetRestriction is configured for K CSI-RS resources
The selected L CRI is indicated by bitmap or combinational number.
The L sets of RI, PMI, CQI are reported according to the ascending/descending order of the associated CSI-RS resource ID.

Here, codebookSubsetRestrictions represents a parameter that controls restrictions on reported parameters e.g., as described in TS 38.214 standard of 3GPP. This codebook subset restriction parameter may be configured by BS or alternatively selected based on UE capability.

Regarding L CQIs, embodiments may adopt the following features.
For each CQI in the L set, the each CQI consist of one wideband reference CQI and F subband differential CQIs. Each wideband reference CQI occupy 4 bits and each subband differential CQI occupy 2 bits.
The L CQIs consist of one wideband reference CQI and F*L subband differential CQIs. The wideband reference CQI occupy 4 bits and each subband differential CQI occupy 2 bits. Each subband differential CQI is associated with the wideband reference CQI.
The L CQIs consist of one wideband reference CQI, L−1 wideband differential CQIs and F*L subband differential CQIs. The wideband reference CQI occupy 4 bits, each wideband differential CQI occupy 2 bits and each subband differential CQI occupy 2 bits.
The L CQIs consist of L wideband reference CQIs, F first-subband differential CQIs and F*(L−1) second-subband differential CQIs. Each wideband reference CQI occupy 4 bits and each first-subband differential CQI occupy 2 bits, and each second-subband differential CQI occupy 1 bits. Each of the second-subband differential CQI is differentiated from each of the first-subband differential CQI.

In some embodiments, the UE report Xϵ{1, 2, 3, . . . , L} CQIs for each subband in the CSI reporting band, if cqi-FormatIndicator is set to ‘subbandCQI’, or Xϵ{1,2,3, . . . , L} CQIs for the entire CSI reporting band, if cqi-FormatIndicator is set to ‘widebandCQI’. For example, for X=2, the second CQI includes a 4-bit wideband CQI index and, if subband CQI reporting is configured, a 2-bit subband CQI index, calculated independently from the first CQI, and the two CQIs are reported in the same CSI report.

In some embodiments, some CSI information may be omitted or dropped from the CSI report. Regarding CSI dropping, various embodiments may adopt the following features:
CSI report format in case part of the K CSI-RSs is dropped
   All the L sets of CRI, RI, PMI, CQI are dropped
      UE reports a CSI report only after receiving at least one CSI-RS transmission occasion for each CSI-RS resource in the CSI-RS resource set no later than CSI reference resource and drops the report otherwise.
   Only the corresponding sets of CRI, RI, PMI, CQI are dropped
      UE reports a CSI report only after receiving at least one CSI-RS transmission occasion for at least one CSI-RS resource in the CSI-RS resource set no later than CSI reference resource and drops the report otherwise.

### Embodiment 3: UCI (Uplink Control Information) Mapping for the CSI Report

Various example implementations are described with reference to Table 1 to Table 8.

In some implementations according to embodiment 3, K CSI-RS resources are configured by gNB for channel measurement. K is a positive integer and may be greater than 1.

In some embodiments, UE determines L sets of CRI, RI, PMI, CQI within a CSI report. 1<=L<=K, The value of L is configured by gNB or reported by UE

The CSI report comprises at least two parts. CSI part 1 and CSI part 2. The format of each part may depend on the physical channel used for transmission of the CSI report.

### Embodiment 3-1: CSI Reporting Using PUCCH

In some embodiments, CSI reporting using PUCCH may be performed as follows.

The CSI report comprises of two parts. CSI part 1 and CSI part 2.

### For Type I CSI Feedback

Part 1 contains L RI(s), the bitmap selecting L CSI-RS resources (if reported), L CQI(s) for the first codeword and is zero padded to a fixed payload size (if needed). Part 2 contains the L CQI(s) for the second codeword (if reported) when RI is larger than 4, L LIs (if reported) and L PMI(s).
Part 1 contains L RI(s), L CRI(s), L CQI(s) for the first codeword and is zero padded to a fixed payload size (if needed). Part 2 contains the L CQI(s) for the second codeword (if reported) when RI is larger than 4, L LIs (if reported) and L PMI(s). Table 1 shows example fields used for CSI part 1.

TABLE 1

| | |
|---|---|
| CSI part 1 | 1st CRI |
| fields | 1st RI |
| | 1st WB CQI for the first TB |
| | 1st Subband differential CQI for the first TB |
| | with increasing order of subband number |
| | 2nd CRI |
| | 2nd RI |
| | 2nd WB CQI for the first TB |
| | 2nd Subband differential CQI for the first TB |
| | with increasing order of subband number |
| | . . . |
| | L-th CRI |
| | L-th RI |
| | L-th WB CQI for the first TB |
| | L-th Subband differential CQI for the first TB |
| | with increasing order of subband number |

In some embodiments, the CSI part 2 comprises of two parts. CSI part 2 wideband and CSI part 2 subband.

In some embodiments, PMI comprises of two parts. PMI fields X₁ and PMI fields X₂. Table 2 lists example fields of a CSI part 2 structure of the report.

TABLE 2

| | |
|---|---|
| CSI part 2 | 1st Wideband CQI for the second TB |
| wideband fields | 1st Layer Indicator |
| | 1st PMI wideband information fields X₁ |
| | 1st PMI wideband information fields X₂ |
| | 2nd Wideband CQI for the second TB |
| | 2nd Layer Indicator |
| | 2nd PMI wideband information fields X₁ |
| | 2nd PMI wideband information fields X₂ |
| | . . . |
| | L-th Wideband CQI for the second TB |
| | L-th Layer Indicator |
| | L-th PMI wideband information fields X₁ |
| | L-th PMI wideband information fields X₂ |

Table 3 shows an example of fields of a CSI part 2 subband report.

TABLE 3

| | |
|---|---|
| CSI part 2 | 1st Subband differential CQI for the |
| subband fields | second TB of all even subbands with |
| | increasing order of subband number |
| | 1st PMI subband information fields X₂ |
| | of all even subbands with increasing |
| | order of subband number |
| | 2nd Subband differential CQI for the |
| | second TB of all even subbands with |
| | increasing order of subband number |
| | 2nd PMI subband information fields X₂ |
| | of all even subbands with increasing |
| | order of subband number |
| | . . . |
| | L-th Subband differential CQI for the |
| | second TB of all even subbands with |
| | increasing order of subband number |
| | L-th PMI subband information fields X₂ |
| | of all even subbands with increasing |
| | order of subband number |
| | 1st Subband differential CQI for the |
| | second TB of all odd subbands with |
| | increasing order of subband number |
| | 1st PMI subband information fields X₂ |
| | of all odd subbands with increasing |
| | order of subband number |
| | 2nd Subband differential CQI for the |
| | second TB of all odd subbands with |
| | increasing order of subband number |
| | 2nd PMI subband information fields X₂ |
| | of all odd subbands with increasing |
| | order of subband number |
| | . . . |
| | L-th Subband differential CQI for the |
| | second TB of all odd subbands with |
| | increasing order of subband number |
| | L-th PMI subband information fields X₂ |
| | of all odd subbands with increasing |
| | order of subband number |

### Embodiment 3-2: CSI Reporting Using PUSCH

In some embodiments, CSI reporting may be performed using PUSCH.

In some embodiments, this CSI report comprises of two parts, referred to as CSI part 1 and CSI part 2.

In some embodiments, for Type I CSI feedback, the following features may be adopted:
Part 1 contains L RI(s), the bitmap selecting L CSI-RS resources (if reported), L CQI(s) for the first codeword and is zero padded to a fixed payload size (if needed). Part 2 contains the L CQI(s) for the second codeword (if reported) when RI is larger than 4, L Us (if reported) and L PMI(s), or
Part 1 contains L RI(s), L CRI(s), L CQI(s) for the first codeword and is zero padded to a fixed payload size (if needed). Part 2 contains the L CQI(s) for the second codeword (if reported) when RI is larger than 4, L Us (if reported) and L PMI(s). Table 4 lists an example of fields of CSI part 1.

TABLE 4

| | |
|---|---|
| CSI part | 1st CRI |
| 1 fields | 1st RI |
| | 1st WB CQI for the first TB |
| | 1st Subband differential CQI for the first TB with |
| | increasing order of subband number |
| | 2nd CRI |
| | 2nd RI |
| | 2nd WB CQI for the first TB |
| | 2nd Subband differential CQI for the first TB with |
| | increasing order of subband number |
| | . . . |
| | L-th CRI |
| | L-th RI |
| | L-th WB CQI for the first TB |
| | L-th Subband differential CQI for the first TB with |
| | increasing order of subband number |

In some embodiments, the CSI part 2 comprises of two parts. CSI part 2 wideband and CSI part 2 subband.

In some embodiments, PMI comprises of two parts. PMI fields X₁ and PMI fields X₂.

Table 5 and Table 6 show examples of CSI part 2 wideband fields and CSI part 2 subband fields, respectively.

TABLE 5

| | |
|---|---|
| CSI part 2 | 1st Wideband CQI for the second TB |
| wideband fields | 1st Layer Indicator |
| | 1st PMI wideband information fields X₁ |
| | 1st PMI wideband information fields X₂ |
| | 2nd Wideband CQI for the second TB |
| | 2nd Layer Indicator |
| | 2nd PMI wideband information fields X₁ |
| | 2nd PMI wideband information fields X₂ |
| | . . . |
| | L-th Wideband CQI for the second TB |
| | L-th Layer Indicator |
| | L-th PMI wideband information fields X₁ |
| | L-th PMI wideband information fields X₂ |

TABLE 6

| | |
|---|---|
| CSI part 2 | 1st Subband differential CQI for the |
| subband fields | second TB of all even subbands with |
| | increasing order of subband number |
| | 1st PMI subband information fields X₂ |
| | of all even subbands with increasing |
| | order of subband number |
| | 2nd Subband differential CQI for the |
| | second TB of all even subbands with |
| | increasing order of subband number |
| | 2nd PMI subband information fields X₂ |
| | of all even subbands with increasing |
| | order of subband number |
| | . . . |
| | L-th Subband differential CQI for the |
| | second TB of all even subbands with |
| | increasing order of subband number |
| | L-th PMI subband information fields X₂ |
| | of all even subbands with increasing |
| | order of subband number |
| | 1st Subband differential CQI for the |
| | second TB of all odd subbands with |
| | increasing order of subband number |
| | 1st PMI subband information fields X₂ |
| | of all odd subbands with increasing |
| | order of subband number |
| | 2nd Subband differential CQI for the |
| | second TB of all odd subbands with |
| | increasing order of subband number |
| | 2nd PMI subband information fields X₂ |
| | of all odd subbands with increasing |
| | order of subband number |
| | . . . |
| | L-th Subband differential CQI for the |
| | second TB of all odd subbands with |
| | increasing order of subband number |
| | L-th PMI subband information fields X₂ |
| | of all odd subbands with increasing |
| | order of subband number |

In some embodiments, the CSI report comprises of two parts. CSI part 1 and CSI part 2. The following features may be implemented:

### For Enhanced Type II CSI Feedback:

Part 1 contains LRI(s) (if reported), L CQI(s), the total number of reported non-zero amplitude coefficients across layers for each of selecting CSI-RS resources, the bitmap selecting L CSI-RS resources (if reported). The fields of Part 1—LRI(s) (if reported), L CQI(s), the total number of reported non-zero amplitude coefficients across layers, the bitmap selecting L CSI-RS resources (if reported)—are separately encoded. Part 2 contains the L PMI(s) of the selecting L CSI-RS resources. Part 1 and 2 are separately encoded. Table 7 shows one example of fields of CSI part 1 fields according to these features.

TABLE 7

| | |
|---|---|
| CSI part | Indicator of the L selected CSI-RS resources by |
| 1 fields | a bitmap with K bits |
| | 1st RI |
| | 1st Wideband CQI for the first TB |
| | 1st Subband differential CQI for the first TB |
| | with increasing order of subband number |
| | 1st total number of reported non-zero amplitude |
| | coefficients across layers |
| | 2nd RI |
| | 2nd Wideband CQI for the first TB |
| | 2nd Subband differential CQI for the first TB |
| | with increasing order of subband number |
| | 2nd total number of reported non-zero amplitude |
| | coefficients across layers |
| | . . . |
| | L-th RI |
| | L-th Wideband CQI for the first TB |
| | L-th Subband differential CQI for the first TB |
| | with increasing order of subband number |
| | L-th total number of reported non-zero amplitude |
| | coefficients across layers |

In some embodiments, for Enhanced Type II CSI feedback, the CSI part 2 comprises of three parts. CSI part 2 group 0, CSI part 2 group 1 and CSI part 2 group 2.

In some embodiments, PMI comprises of two parts. PMI fields X₁ and PMI fields X₂.

Table 8 shows example fields of different groups of CSI part 2.

TABLE 8

| | |
|---|---|
| CSI part 2 group 0 | 1st PMI fields X₁ |
| | 2nd PMI fields X₁ |
| | . . . |
| | L-th PMI fields X₁ |
| CSI part 2 group 1 | Part of PMI fields X₂ of 1st |
| | Part of PMI fields X₂ of 2nd |
| | . . . |
| | Part of PMI fields X₂ of L-th |
| CSI part 2 group 2 | Remaining Part of PMI fields X₂ of 1st |
| | Remaining Part of PMI fields X₂ of 2nd |
| | . . . |
| | Remaining Part of PMI fields X₂ of L-th |

### Embodiment 4: Priority Rule for CSI Part 2

In current specification TS 38.214 clause 5.2.5 is as follows:

CSI reports are associated with a priority value Pri_{iCSI}(y, k, c, s) = 2 · N_{cells} ·
Mₛ · y + N_{cells} · Mₛ · k + Mₛ · c + s where

| | |
|---|---|
| - | y = 0 for aperiodic CSI reports to be carried on PUSCH y = 1 for semi- |
| | persistent CSI reports to be carried on PUSCH, y = 2 for semi-persistent |
| | CSI reports to be carried on PUCCH and y = 3 for periodic CSI reports to |
| | be carried on PUCCH; |
| - | k = 0 for CSI reports carrying L1-RSRP or L1-SINR and k = 1 for CSI |
| | reports not carrying L1-RSRP or L1-SINR; |
| - | c is the serving cell index and N_{cells} is the value of the higher layer |
| | parameter maxNrofServingCells; |
| - | s is the reportConfigID and Mₛ is the value of the higher layer parameter |
| | maxNrofCSI-ReportConfigurations. |

A first CSI report is said to have priority over second CSI report if the associated
Pri_{iCSI}(y, k, c, s) value is lower for the first report than for the second report.

In some embodiments according to the present document, the CSI report, consisting of L sets of CRI, RI, PMI, CQI may be implemented using priorities as below:

In some embodiments, the CSI report has the same priority as the CSI reports not carrying L1-RSRP or L1-SINR.

In some embodiments, k=0 can be used for calculating the priority of the CSI report.

Alternatively, in some embodiments, the CSI report has the different priority from the CSI reports not carrying L1-RSRP or L1-SINR. Here,
k=1 can be used for calculating the priority of the CSI report, and/or
k=2 can be used for calculating the priority of the CSI report.

The following technical solutions may be adopted by some preferred embodiments.

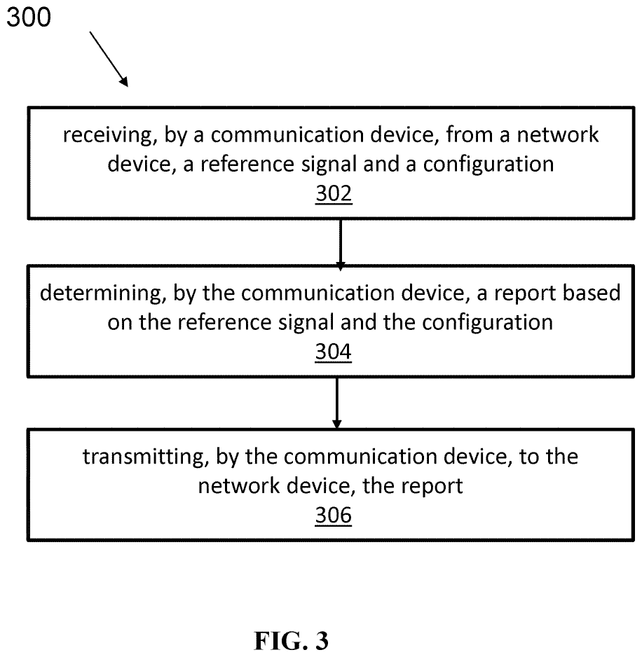

1. A method of wireless communication (e.g., method 300 depicted in FIG. 3), comprising: receiving (302), by a communication device, from a network device, a reference signal and a configuration; determining (304), by the communication device, a report based on the reference signal and the configuration; and transmitting (306), by the communication device, to the network device, the report.

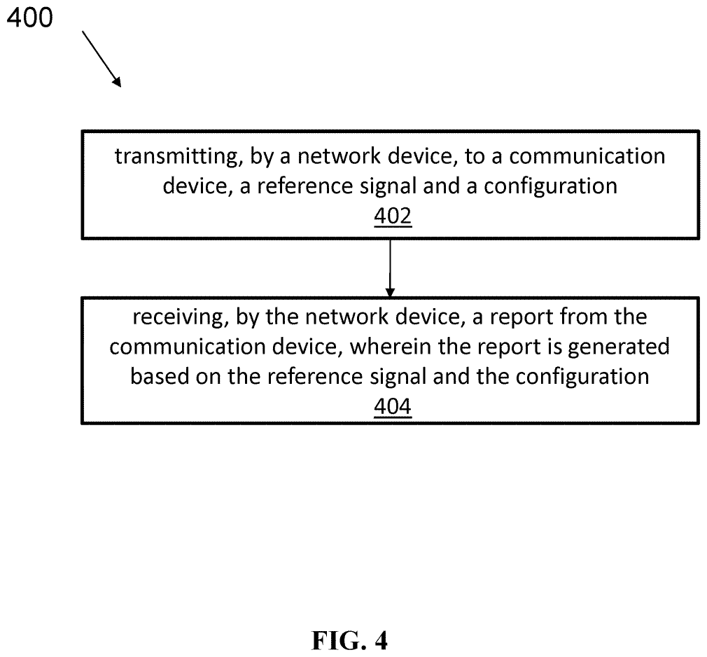

2. A method of wireless communication (e.g., method 400 depicted in FIG. 4), comprising: transmitting (402), by a network device, to a communication device, a reference signal and a configuration; and receiving (404), by the network device, a report from the communication device, wherein the report is generated based on the reference signal and the configuration.

3. The method of solution 1, wherein the reference signal comprises channel state information reference signal (CSI-RS) and wherein the report comprises CSI.

4. The method of any of solutions 1-3, wherein the CSI includes one or more of: a plurality of channel quality indicators (CQIs), a plurality of precoding matrix indicators (PMIs), a plurality of layer indicators (LIs), a plurality of rank indicators (RIs) or a plurality of reference signal resource indicators. One example of a reference signal resource indicator is the CSI-RS resource indicator (CRI).

5. The method of solution 1, wherein the reference signal comprises K resources, wherein K is a positive integer, and wherein the K resources are configured within Xϵ{1, 2, . . . N}, where X and N are positive numbers.

6. The method of any of solutions 1-5, wherein the K resources are configured in a resource set, wherein each resource of the resource set contains up to 32 or more reference signal ports, wherein time offsets between the resources in the resource set are configured according to a rule. The present document, referring to embodiments 1 to 3 provides various examples of the rule.

7. The method of solution 6, wherein the rule specifies a maximum or a minimum time offset between adjacent reference signal resources that is specified by the network device or is according to a capability of the communication device.

8. The method of any of solutions 1-7, wherein the K resources are configured in a single resource set or in G resource groups, where G is positive integer greater than 1 that is configured by the network device or is according to a capability of the communication device.

9. The method of solution 5, wherein the K resources are configured for channel measurements.

10. The method of solution 9, including: determining, by the wireless device, L sets of channel quality indicators, precoding matrix indicators, layer indicators, rank indicators or reference signal resource indicators, wherein L is an integer 1<=L<=K, and wherein L is specified by the wireless device or the network device, or reporting, by the wireless device, the report only after receiving at least one CSI-RS transmission occasion for each CSI-RS resource in the K resources no later than CSI reference resource and drops the report otherwise. From the BS perspective, this solution may include receiving, by the BS, the L sets determined by the wireless device.

11. The method of solution 9, wherein:
K specific rank indicator restrictions are configured for K resources;
a common rank indicator restriction is configured for K resources;
K specific codebook subset restrictions are configured for K resources;
a common codebook subset restriction is configured for K resources
a number L of selected resource indicators is indicated by a bitmap or a combinational number; or
L sets of rank indicators, precoding matrix indicators, or channel quality indicators are reported according to an ascending or a descending order of associated resource ID.

12. The method of solution 4, wherein, each CQI in the plurality of CQI(s) consists of one wideband reference CQI and F subband differential CQIs, with value of F being associated with a corresponding subband number, or the plurality of CQI(s) consist of one wideband reference CQI and F subband differential CQIs, with value of F being associated with a corresponding subband number.

13. The method of solution 12, wherein the one wideband reference CQI occupy 4 bits and each of the subband differential CQIs occupy 2 bits.

14. The method of any of solutions 1-13, wherein the report is transmitted such that a part of the report is omitted from the transmission, wherein the part that is omitted includes the L sets of rank indicators, precoding matrix indicators, or channel quality indicators. From the BS perspective, the reported in received based such that some information has been omitted from the report.

15. The method of solution 10, wherein the report comprises a first part, part 1, and a second part, part 2.

16. The method of solution 15, wherein the part 1 includes one or more of: a plurality of RIs, a plurality of CRIs, a bitmap that indicates reference signal resources or a plurality of CQIs selected for a first codeword.

17. The method of solution 15, a mapping order of one or more fields of the report comprises:
for mapping to the part 1:
a first CRI in the plurality of CRI(s), a first RI in the plurality of RI(s), a first wideband (WB) CQI for a first transport block (TB) in the plurality of CQI(s), a first subband differential CQI for the first TB with increasing order of subband number in the plurality of CQI(s),
a second CRI in the plurality of CRI(s), a second RI in the plurality of RI(s), a second WB CQI for the first TB in the plurality of CQI(s) or a second subband differential CQI for the first TB with increasing order of subband number in the plurality of CQI(s), in that order.

18. The method of any of solutions 15-17, wherein the part 2 includes one or more of: a plurality of CQI(s) for the second codeword when RI is larger than 4, a plurality of Us or a plurality of PMI(s).

19. The method of solution 15, wherein the part 2 comprise CSI part 2 wideband and CSI part 2 subband.

20. The method of solution 18, wherein each PMI in the plurality of PMI(s) comprise PMI fields X₁ and PMI fields X₂.

21. The method of solution 19, a mapping order of one or more CSI fields of the CSI report comprises:
for mapping to the CSI part 2 wideband:
a first wideband (WB) CQI for a second TB in the plurality of CQI(s), a first LI in the plurality of LI(s), a first PMI wideband information fields X₁ in the plurality of PMI(s), a first PMI wideband information fields X₂ in the plurality of PMI(s),
a second WB CQI for the second TB in the plurality of CQI(s), a second LI in the plurality of LI(s), a second PMI wideband information fields X₁ in the plurality of PMI(s), or a second PMI wideband information fields X₂ in the plurality of PMI(s), in that order.

22. The method of solution 19, a mapping order of one or more CSI fields of the CSI report comprises:
for mapping to the CSI part 2 subband:
an i^{th} subband differential CQI for a second transport block (TB) followed by an i^{th} PMI information fields for all even subbands with increasing order of subband numbers, wherein i is from 1 to L; followed by
an i^{th} subband differential CQI for a second transport block (TB) followed by an i^{th} PMI information fields for all odd subbands with increasing order of subband numbers, wherein i is from 1 to L;

23. The method of solution 15, wherein the part 2 comprise CSI part 2 group 0, CSI part 2 group 1 and CSI part 2 group 2.

24. The method of solution 23, a mapping order of one or more CSI fields of the CSI report comprises:
for mapping to the CSI part 2 group 0:
i^{th} wideband CQI, i^{th} LI, i^{th} PMI wideband information fields X₁, i^{th} PMI wideband information fields X₂, wherein i is from 1 to L.

25. The method of solution 23, a mapping order of one or more CSI fields of the CSI report comprises:
for mapping to the CSI part 2 group 1:
i^{th} subband differential CQI for a second transport block, i^{th} PMI wideband information fields X₂, for even subbands in an increasing order, where i is from 1 to L, followed by
i^{th} subband differential CQI for a second transport block, i^{th} PMI wideband information fields X₂, for odd subbands in an increasing order, wherein i is from 1 to L.

26. The method of solution 23, a mapping order of one or more CSI fields of the CSI report comprises:
for mapping to the CSI part 2 group 2:
remaining parts of PMI fields X₂ of i^{th} subband, wherein i is from 1 to L.

27. The method of any of solutions 1-26, wherein the report is reported using physical uplink control channel PUCCH or physical uplink shared channel PUSCH.

28. The method of solution 10, wherein the report comprises at least two parts, wherein formats of the at least two parts are defined according to a physical channel used for transmission of the report.

29. The method of solution 13, wherein the at least two parts comprise a part 1 and a part 2, and wherein the physical channel used for the transmission of the report comprises an uplink control channel or an uplink shared channel.

30. The method of solution 1, wherein the report is transmitted according to a priority value that is determined to be:

Pri_{iCSI}(y,k,c,s)=2·N_{cells}·Mₛ·y+N_{cells}·Mₛ·k+Mₛ·c+s

where,
y is a variable that depends on a physical channel on which the report is transmitted, k is a variable according to a type of report, c is a variable according to a serving cell index, s is a variable according to an identifier of a configuration used by the report and N_{cells} and Mₛ are values configured by the network device, wherein the report comprises L sets of channel quality indicators, precoding matrix indicators, layer indicators, rank indicators or reference signal resource indicators.

31. The method of solution 30, wherein the report has a same priority level as a report not carrying a layer 1 reference signal received power report or a layer 1 signal to interference plus noise ratio report.

32. The method of solution 30, the report has a different priority level as a report not carrying a layer 1 reference signal received power report or a layer 1 signal to interference plus noise ratio report.

33. The method of any of solutions 1-32, wherein k=0, 1, or 2.

34. An apparatus for wireless communication, comprising at least one processor configured to perform a method recited in any of solutions 1-33.

35. A computer-storage medium having code stored thereon, the code, upon execution by at least one processor, causing the at least one processor to implement an above-described solutions 1-33.

In the above-reference solutions, the various variables i, k, L, K, F, etc. take on integer values.

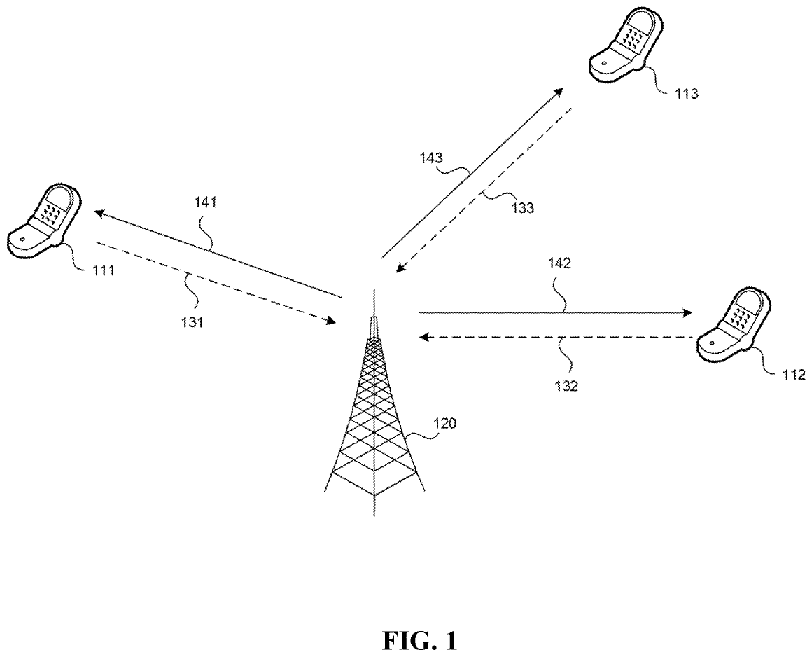

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., radio link layer messages), or uplink information. In some embodiments, the downlink transmissions (141, 142, 143) can include DCI, reference signal configuration, reference signal transmissions, or high layer signaling or other downlink information. The UE may be, for example, a smartphone, a tablet, a mobile computer, a machine to machine (M2M) device, a terminal, a mobile device, an Internet of Things (IoT) device, and so on. The disclosed techniques may be implemented by the UE 111, 112 and/or 113.

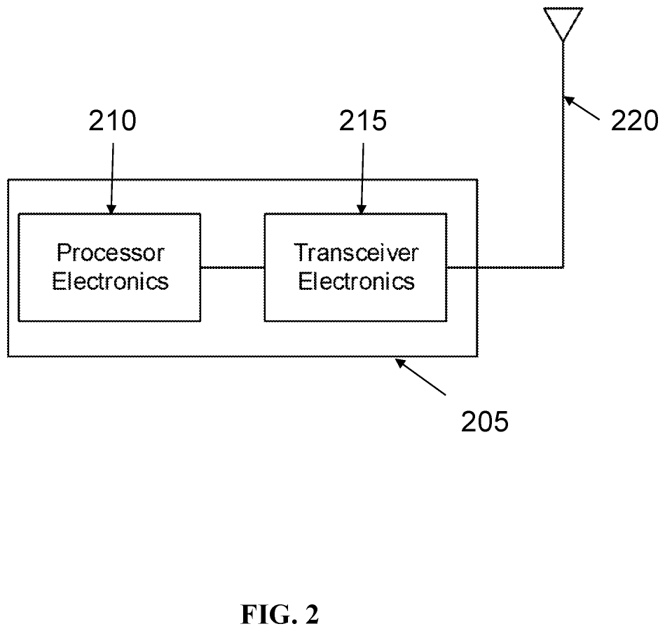

FIG. 2 is a block diagram representation of a portion of an apparatus, in accordance with some embodiments of the presently disclosed technology. An apparatus 205 such as a network device or a base station or a wireless device (or UE), can include processor electronics 210 such as at least one processor or microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

In the present document, UE or communication device may comprise a mobile phone, smartphone, laptop or any other electronic device capable of wireless communication. In the present document base station BS may be gNB (the next Generation Node B), wireless network device, or TRP (Transmission and Reception Point). In the present document, “antenna port” can be equivalent to “BS antenna port”, or “CSI-RS (Channel State Information Reference Signal) antenna port” and “higher layer parameter” can be equivalent to “RRC (Radio Resource Control) parameter.” It will also be appreciated that although the above described techniques are described with reference to various embodiments, the formats and ordering described in one embodiments may suitably be adopted with format and field ordering of other embodiments.

It will be appreciated that the present document provides techniques for codebook enhancement to support PMI reporting with more than 32 antenna ports. The DL precoding performance is guaranteed with reduced PMI reporting overhead.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

1. A method of wireless communication, comprising:
receiving, by a communication device, from a network device, a reference signal and a configuration;
determining, by the communication device, a report based on the reference signal and the configuration; and
transmitting, by the communication device, to the network device, the report.

2. The method of claim 1, wherein the reference signal comprises K resources, wherein K is a positive integer, and wherein the K resources are configured within Xϵ{1, 2, . . . N}, where X and N are positive numbers.

3. The method of claim 2, including:
determining, by the wireless device, L sets of channel quality indicators, precoding matrix indicators, layer indicators, rank indicators or reference signal resource indicators, wherein L is an integer 1<=L<=K, and wherein L is specified by the wireless device or the network device, or
reporting, by the wireless device, the report only after receiving at least one CSI-RS transmission occasion for each CSI-RS resource in the K resources no later than CSI reference resource and drops the report otherwise.

4. The method of claim 2, wherein:
K specific rank indicator restrictions are configured for K resources;
a common rank indicator restriction is configured for K resources;
K specific codebook subset restrictions are configured for K resources;
a common codebook subset restriction is configured for K resources
a number L of selected resource indicators is indicated by a bitmap or a combinational number; or
L sets of rank indicators, precoding matrix indicators, or channel quality indicators are reported according to an ascending or a descending order of associated resource ID.

5. The method of claim 1, wherein a mapping order of one or more fields of the report comprises:
for mapping to a part 1:
a first CRI in a plurality of CRI(s), a first RI in a plurality of RI(s), a first wideband (WB) CQI for a first transport block (TB) in a plurality of CQI(s), a first subband differential CQI for the first TB with increasing order of subband number in the plurality of CQI(s),
a second CRI in the plurality of CRI(s), a second RI in the plurality of RI(s), a second WB CQI for the first TB in the plurality of CQI(s) or a second subband differential CQI for the first TB with increasing order of subband number in the plurality of CQI(s), in that order.

6. The method of claim 1, wherein the report comprises a channel state information (CSI) report, and a mapping order of one or more CSI fields of the CSI report comprises:
for mapping to CSI part 2 wideband:
a first wideband (WB) CQI for a second TB in a plurality of CQI(s), a first LI in the plurality of LI(s), a first PMI wideband information fields X₁ in a plurality of PMI(s), a first PMI wideband information fields X₂ in a plurality of PMI(s),
a second WB CQI for the second TB in the plurality of CQI(s), a second LI in the plurality of LI(s), a second PMI wideband information fields X₁ in the plurality of PMI(s), or a second PMI wideband information fields X₂ in the plurality of PMI(s), in that order.

7. The method of claim 1, wherein the report comprises a channel state information (CSI) report, and a mapping order of one or more CSI fields of the CSI report comprises:
for mapping to CSI part 2 subband:
an i^{th} subband differential CQI for a second transport block (TB) followed by an i^{th} PMI information fields for all even subbands with increasing order of subband numbers, wherein i is from 1 to L; followed by
an i^{th} subband differential CQI for a second transport block (TB) followed by an i^{th} PMI information fields for all odd subbands with increasing order of subband numbers, wherein i is from 1 to L.

8. The method of claim 3, wherein the report comprises a channel state information (CSI) report, and wherein a mapping order of one or more CSI fields of the CSI report comprises:
for mapping to CSI part 2 group 0:
i^{th} wideband CQI, i^{th} LI, i^{th} PMI wideband information fields X₁, i^{th} PMI wideband information fields X₂, wherein i is from 1 to L.

9. The method of claim 1, wherein the report comprises a channel state information (CSI) report, and wherein a mapping order of one or more CSI fields of the CSI report comprises:
for mapping to CSI part 2 group 1:
i^{th} subband differential CQI for a second transport block, i^{th} PMI wideband information fields X₂, for even subbands in an increasing order, where i is from 1 to L, followed by
i^{th} subband differential CQI for a second transport block, i^{th} PMI wideband information fields X₂, for odd subbands in an increasing order, wherein i is from 1 to L.

10. The method of claim 3, wherein the report comprises a channel state information (CSI) report, and a mapping order of one or more CSI fields of the CSI report comprises:
for mapping to CSI part 2 group 2:
remaining parts of PMI fields X₂ of h subband, wherein i is from 1 to L.

11. An apparatus for wireless communication, comprising at least one processor configured to implement a method comprising:
receiving, by a communication device, from a network device, a reference signal and a configuration;
determining, by the communication device, a report based on the reference signal and the configuration; and
transmitting, by the communication device, to the network device, the report.

12. The apparatus of claim 11, wherein the reference signal comprises K resources, wherein K is a positive integer, and wherein the K resources are configured within Xϵ{1, 2, . . . N}, where X and N are positive numbers.

13. The apparatus of claim 12, including:
determining, by the wireless device, L sets of channel quality indicators, precoding matrix indicators, layer indicators, rank indicators or reference signal resource indicators, wherein L is an integer 1<=L<=K, and wherein L is specified by the wireless device or the network device, or
reporting, by the wireless device, the report only after receiving at least one CSI-RS transmission occasion for each CSI-RS resource in the K resources no later than CSI reference resource and drops the report otherwise.

14. The apparatus of claim 12, wherein:
K specific rank indicator restrictions are configured for K resources;
a common rank indicator restriction is configured for K resources;
K specific codebook subset restrictions are configured for K resources;
a common codebook subset restriction is configured for K resources
a number L of selected resource indicators is indicated by a bitmap or a combinational number; or
L sets of rank indicators, precoding matrix indicators, or channel quality indicators are reported according to an ascending or a descending order of associated resource ID.

15. The apparatus of claim 11, wherein a mapping order of one or more fields of the report comprises:
for mapping to a part 1:
a first CRI in a plurality of CRI(s), a first RI in a plurality of RI(s), a first wideband (WB) CQI for a first transport block (TB) in a plurality of CQI(s), a first subband differential CQI for the first TB with increasing order of subband number in the plurality of CQI(s),
a second CRI in the plurality of CRI(s), a second RI in the plurality of RI(s), a second WB CQI for the first TB in the plurality of CQI(s) or a second subband differential CQI for the first TB with increasing order of subband number in the plurality of CQI(s), in that order.

16. The apparatus of claim 11, wherein the report comprises a channel state information (CSI) report, and a mapping order of one or more CSI fields of the CSI report comprises:
for mapping to CSI part 2 wideband:
a first wideband (WB) CQI for a second TB in a plurality of CQI(s), a first LI in the plurality of LI(s), a first PMI wideband information fields X₁ in a plurality of PMI(s), a first PMI wideband information fields X₂ in a plurality of PMI(s),
a second WB CQI for the second TB in the plurality of CQI(s), a second LI in the plurality of LI(s), a second PMI wideband information fields X₁ in the plurality of PMI(s), or a second PMI wideband information fields X₂ in the plurality of PMI(s), in that order.

17. The apparatus of claim 11, wherein the report comprises a channel state information (CSI) report, and a mapping order of one or more CSI fields of the CSI report comprises:
for mapping to CSI part 2 subband:
an i^{th} subband differential CQI for a second transport block (TB) followed by an i^{th} PMI information fields for all even subbands with increasing order of subband numbers, wherein i is from 1 to L; followed by
an i^{th} subband differential CQI for a second transport block (TB) followed by an i^{th} PMI information fields for all odd subbands with increasing order of subband numbers, wherein i is from 1 to L.

18. The apparatus of claim 13, wherein the report comprises a channel state information (CSI) report, and wherein a mapping order of one or more CSI fields of the CSI report comprises:
for mapping to CSI part 2 group 0:
i^{th} wideband CQI, i^{th} LI, i^{th} PMI wideband information fields X₁, i^{th} PMI wideband information fields X₂, wherein i is from 1 to L.

19. The apparatus of claim 11, wherein the report comprises a channel state information (CSI) report, and wherein a mapping order of one or more CSI fields of the CSI report comprises:
for mapping to CSI part 2 group 1:
i^{th} subband differential CQI for a second transport block, i^{th} PMI wideband information fields X₂, for even subbands in an increasing order, where i is from 1 to L, followed by
i^{th} subband differential CQI for a second transport block, i^{th} PMI wideband information fields X₂, for odd subbands in an increasing order, wherein i is from 1 to L.

20. An apparatus for wireless communication comprising at least one processor configured to implement a method comprising:
transmitting, by a network device, to a communication device, a reference signal and a configuration; and
receiving, by the network device, a report from the communication device, wherein the report is generated based on the reference signal and the configuration.
